(19) United States
(12) Patent Application Publication
(10) Pub. No.: US 2024/0217600 A1
(43) Pub. Date: Jul. 4, 2024

(54) MOUNTING BRACKET SYSTEM FOR A VEHICLE

(71) Applicant: Black Belt Racing LLC, Seymour, IN (US)

(72) Inventors: Kevin Gene Fleetwood, Seymour, IN (US); Stephen Arpin, China Grove, NC (US); Troy B. Davis, Bloomfield, IN (US)

(73) Assignee: Black Belt Racing LLC, Seymour, IN (US)

(21) Appl. No.: 18/403,055

(22) Filed: Jan. 3, 2024

Related U.S. Application Data
(60) Provisional application No. 63/478,444, filed on Jan. 4, 2023.

(51) Int. Cl. B62D 65/02

(52) U.S. Cl. CPC B62D 65/02

(57) ABSTRACT

A mounting bracket system includes a mounting bracket. The mounting bracket includes a chassis clamp, a part clamp, and an arm connecting the chassis clamp to the part clamp. The chassis clamp is configured to clip onto a chassis of a vehicle. The part clamp is configured to secure a part of the vehicle.

### CROSS REFERENCE TO RELATED APPLICATIONS

This application claims the benefit of U.S. Patent Application No. 63/478,444, filed Jan. 4, 2023, which is hereby incorporated by reference.

### BACKGROUND

With vehicles, proper mounting of various vehicle components in a secure manner is a concern. Due to routine vibrations, impacts, and other issues, the mounting of the components can become loose such that the component is dislodged or even damaged. Vehicles in motorsports, such as dirt track racing and other types of racing, experience even more extreme environments and conditions which can hasten component failure.

Thus, there is a need for improvement in this field.

### SUMMARY

A unique mounting bracket system has been developed to mount various vehicle components or parts to a vehicle in a secure manner. While vehicle components can be permanently attached or otherwise integrated with the vehicle, such as through welding, this was found to be impractical in many cases. For instance, some vehicle components typically need to be repaired, replaced, or even upgraded on occasion. It was found these issues can be exacerbated in the extreme environments or high-performance conditions such as those experienced during racing or off-road adventures. Fasteners, like bolts, are commonly used to secure the parts, because the fasteners provide a secure connection. However, these fasteners normally require tools, such as wrenches, screwdrivers, and so on, in order to install or remove the parts for repair and/or replacement. Sometimes the proper tools for removing the part are hard to find or even unavailable. For example, when travelling off-road and/or in a remote location, the tools needed to replace a damaged part might not be readily available to fix or replace the damaged part. Even when the tool is available, time can be wasted locating the tool and undoing the fastener securing the part. This loss of time can be especially problematic during racing where a loss of even a few seconds can be the difference between winning and losing.

This mounting bracket system has been designed to firmly secure the vehicle component or part to a frame or chassis of the vehicle. At the same time, the mounting bracket system allows the part to be quickly removed and attached manually (i.e., by hand) without any tools or just a few tools. The mounting bracket system includes a mounting bracket that secures the part to a strut or other support member of the frame and/or chassis of the vehicle. In one form, the part is a cannister or reservoir for high-performance shock absorbers such as those used in racing or off-road vehicles. The cannister provides additional volume to receive shock absorber fluid (e.g., oil) and/or gas (e.g., nitrogen) from the shock absorber. The canister helps to dissipate heat and reduce mixing of the fluid and gas so as to facilitate greater control of the shock absorber characteristics. During racing, these canisters are prone to damage such that the cannisters need to be quickly replaced. Moreover, the canisters may need to be swapped out for different ones depending on the desired vehicle handling characteristics. The mounting bracket system allows these shock absorber canisters to be quickly and conveniently replaced by hand (i.e., manually) with little or no tools. In other variations, the mounting bracket system is used to secure other types of parts, such as fuel filters or oil filters.

In some use cases, the mounting bracket system further includes a tie-down strap, such as in the form of a zip tie or cable tie, to further secure the mounting bracket to the strut of the chassis. The mounting bracket has a part clamp, a chassis clamp, and an arm extending between the part clamp and the chassis clamp. The part clamp is configured to secure the part to the vehicle, and the chassis clamp is configured to secure the mounting bracket to the strut or other member of the chassis. The mounting bracket in one version has a unitary construction in which the part clamp, the chassis clamp, and the arm are integrally formed together. In one version, the mounting bracket is made of plastic, and more specifically, the mounting bracket is made by injection molding the plastic. The mounting bracket can be made of other materials, such as metal and/or fiber reinforced materials (e.g., carbon fiber). In the chassis clamp, the mounting bracket in some examples further has a non-slip insert or liner that inhibits rotation or slippage of the mounting bracket relative to the strut.

The part clamp has one or more part prongs configured to grip the part. The part prongs of the part clamp define a part cavity in which the part is received. The part prongs of the part clamp further define a part opening through which the part is received during mounting and removal. The part prongs are flexible and able to bend when the part is inserted into and out of the part opening. Once the part is inserted, the part prongs flex back to grip the part. The flexible nature of the part clamp allows the part to be detachably coupled to the mounting bracket. In one example where the part has a cylindrical shape, the part prongs of the part clamp generally extend in a cylindrical manner so that the part cavity has a cylindrical shape. The part prongs can be shaped in other manners to accommodate parts having different shapes (e.g., shapes that are not cylindrical).

In one example, the chassis clamp defines a liner slot configured to retain the liner in the chassis clamp. The liner slot in one form only extends partially the width of the mounting bracket so as to retain the liner during installation. In one form, the liner slot is T-shaped so as to form a retention joint with the liner. Once more, the liner is adapted to reduce slippage between the chassis clamp and the strut of the chassis. The chassis clamp has one or more chassis prongs configured to grip the strut of the chassis. The chassis prongs of the chassis clamp define a chassis cavity in which the strut is received. The chassis prongs of the chassis clamp further define a chassis opening through which the strut is received during mounting and removal. The chassis prongs are flexible and able to bend when the strut is inserted into and out of the chassis opening. Once the strut is inserted, the chassis prongs flex back to grip the strut of the chassis. The flexible nature of the chassis clamp allows the strut to be detachably coupled to the mounting bracket. In one example where the strut has a cylindrical shape (e.g., a tube), the chassis prongs of the chassis clamp generally extend in a cylindrical manner so that the chassis cavity has a cylindrical shape. The chassis prongs can be shaped in other manners to accommodate struts having different shapes (e.g., shapes that are not cylindrical). In another example the chassis clamp can be permanently affixed to the strut of the chassis to further secure the mounting bracket (e.g., welded) to the vehicle while keeping the flexibility of the part clamp to quickly remove and attached the part manually to the part clamp.

In one example, the part clamp on opposing sides of the part cavity has at least two part prongs that define one or more part strap notches where the strap (e.g., zip tie) extends to further secure the part, if needed. Likewise, the chassis clamp on each side of the chassis cavity has at least two chassis prongs that define one or more chassis strap notches where the strap (e.g., zip tie) extends to further secure the mounting bracket to the strut. The arm defines a strap passage or strap hole through which one or more straps extend to further secure the part and/or strut to the mounting bracket.

To reduce rotational, longitudinal, or other slippage between the chassis clamp and the strut, the liner is sandwiched between the chassis clamp and the strut. The liner has a retention rail that is received in the liner slot of the mounting bracket so as to retain the liner in the chassis clamp. In one form, the rail is T-shaped so as to form a joint with the liner slot. In one form, the liner is made from resilient material, like a foam material and/or rubber padding material, that increases friction between the mounting bracket and the strut. In one particular embodiment, the non-slip liner is a rubber padding liner made of an elastic material, such as thermoplastic polyurethane (TPU).

During assembly, the T shaped rail of the liner is inserted into the T-shaped slot of the chassis clamp. During installation, the chassis clamp with the liner is clipped onto the strut. In some cases, the tie-down strap, such as the zip tie, is threaded through the strap passage in the arm. The tie-down strap is looped through the chassis strap notches between the chassis prongs of the chassis clamp, and once the mounting bracket is properly positioned, the strap is tightened further securing the chassis clamp to the strut of the chassis. The part, such as the shock absorber cannister, is then clipped to the part clamp of the mounting bracket. In other variations, the part is secured to the part clamp before or at the same time as the chassis clamp is secured to the chassis. Alternatively or additionally, one or more straps can be used to further secure the part to the mounting bracket.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a mounting bracket system.

Aspect 3 generally concerns the system of any previous aspect including a mounting bracket.

Aspect 4 generally concerns the system of any previous aspect including a chassis mount configured to clip onto a chassis of a vehicle.

Aspect 5 generally concerns the system of any previous aspect in which the part clamp configured to secure a part of the vehicle.

Aspect 6 generally concerns the system of any previous aspect in which the part clip has one or more part prongs.

Aspect 7 generally concerns the system of any previous aspect in which the part prongs define a part strap notch.

Aspect 8 generally concerns the system of any previous aspect in which the chassis mount has one or more chassis prongs.

Aspect 9 generally concerns the system of any previous aspect in which the vehicle part includes a shock absorber cannister.

Aspect 10 generally concerns the system of any previous aspect in which the vehicle part includes a fuel filter.

Aspect 11 generally concerns the system of any previous aspect including an arm connecting the chassis clamp to the part clamp.

Aspect 12 generally concerns the system of any previous aspect in which the arm defines a strap passage through which the strap extends.

Aspect 13 generally concerns the system of any previous aspect in which the chassis mount configured to couple to a chassis of a racing vehicle.

Aspect 14 generally concerns the system of any previous aspect in which the part clip configured to attach to an additional racing part by manual operation.

Aspect 15 generally concerns the system of any previous aspect in which the chassis mount is coupled to the part clip.

Aspect 16 generally concerns the system of any previous aspect including an arm connecting the chassis mount to the part clip.

Aspect 17 generally concerns the system of any previous aspect including a liner disposed in the chassis prongs to prevent slippage between the chassis prongs and the chassis.

Aspect 18 generally concerns the system of any previous aspect in which the chassis prongs define a liner slot.

Aspect 19 generally concerns the system of any previous aspect in which the chassis prongs define a chassis strap notch.

Aspect 20 generally concerns the system of any previous aspect including a strap extending through the chassis strap notch.

Aspect 21 generally concerns the system of any previous aspect in which the strap is configured to secure the mounting bracket to the chassis.

Aspect 22 generally concerns the system of any previous aspect in which the strap is configured to secure the additional racing part to the mounting bracket.

Aspect 23 generally concerns the system of any previous aspect in which the strap includes a zip tie.

Aspect 24 generally concerns the system of any previous aspect in which the chassis mount defines a liner slot.

Aspect 25 generally concerns the system of any previous aspect in which the liner has a rail received in the liner slot.

Aspect 26 generally concerns the system of any previous aspect including a liner disposed in the chassis mount to prevent slippage between the chassis mount and the chassis.

Aspect 27 generally concerns the system of any previous aspect in which the strap is configured to secure the mounting bracket.

Aspect 28 generally concerns the system of any previous aspect in which the part prongs are configured to clip to a vehicle part.

Aspect 29 generally concerns the system of any previous aspect including an arm coupled to the part prongs.

Aspect 30 generally concerns the system of any previous aspect in which the chassis prongs are configured to clip to a chassis of a vehicle.

Aspect 31 generally concerns the system of any previous aspect in which the chassis prongs are coupled to the arm.

Aspect 32 generally concerns a method.

Aspect 33 generally concerns the system of any previous aspect in which the method of assembling the system.

Aspect 34 generally concerns the method of any previous aspect including decoupling a part clip of a mounting bracket from a racing part through manual operation.

Aspect 35 generally concerns the method of any previous aspect including coupling a replacement racing part to the part clip through manual operation.

Aspect 36 generally concerns the method of any previous aspect including coupling the mounting bracket to a vehicle.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a mounting bracket system.

FIG. 2 is a top view of the FIG. 1. mounting bracket system.

FIG. 3 is a top view of the mounting bracket with a liner of the mounting bracket system.

FIG. 4 is a perspective view of the mounting bracket.

FIG. 5 is a side view of the mounting bracket.

FIG. 6 is a front view of the mounting bracket.

FIG. 7 is a rear view of the mounting bracket.

FIG. 8 is a perspective view of the liner.

FIG. 9 is a top view of the liner.

FIG. 10 is a side view of the liner.

FIG. 11 is a front view of the liner.

FIG. 12 is a perspective view of another embodiment of the mounting bracket system.

FIG. 13 is a top view of the FIG. 12 mounting bracket system.

FIG. 14 is a top view of the FIG. 12 mounting bracket.

FIG. 15 is a perspective view of the FIG. 12 mounting bracket.

FIG. 16 is a side view of the FIG. 12 mounting bracket.

FIG. 17 is a front view of the FIG. 12 mounting bracket.

FIG. 18 is a rear view of the FIG. 12 mounting bracket.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

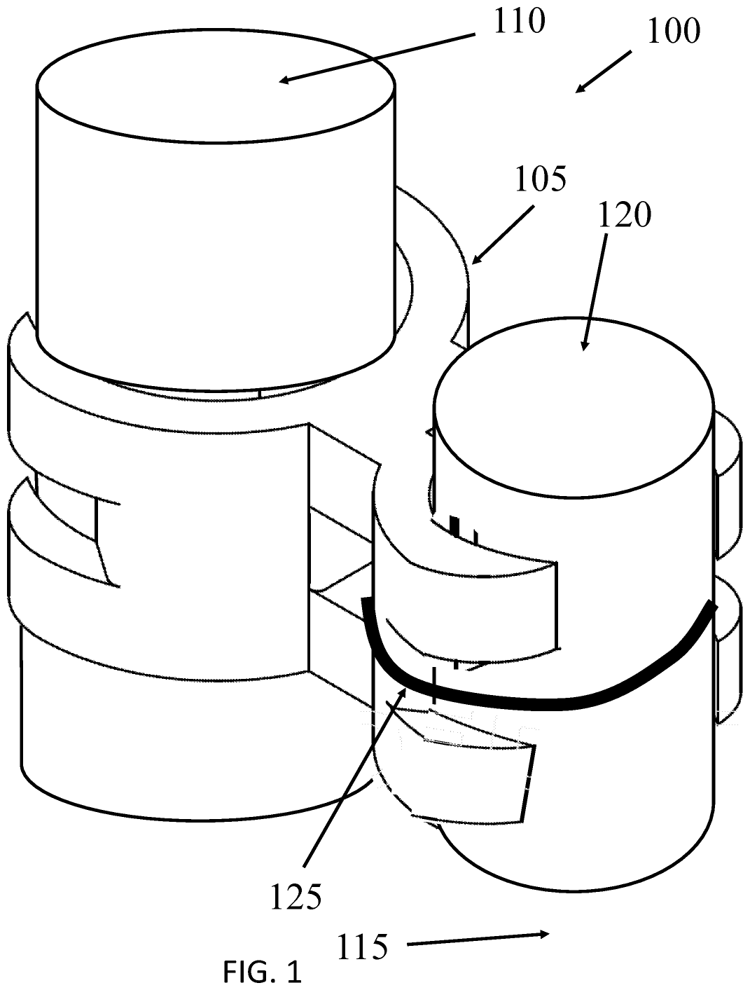

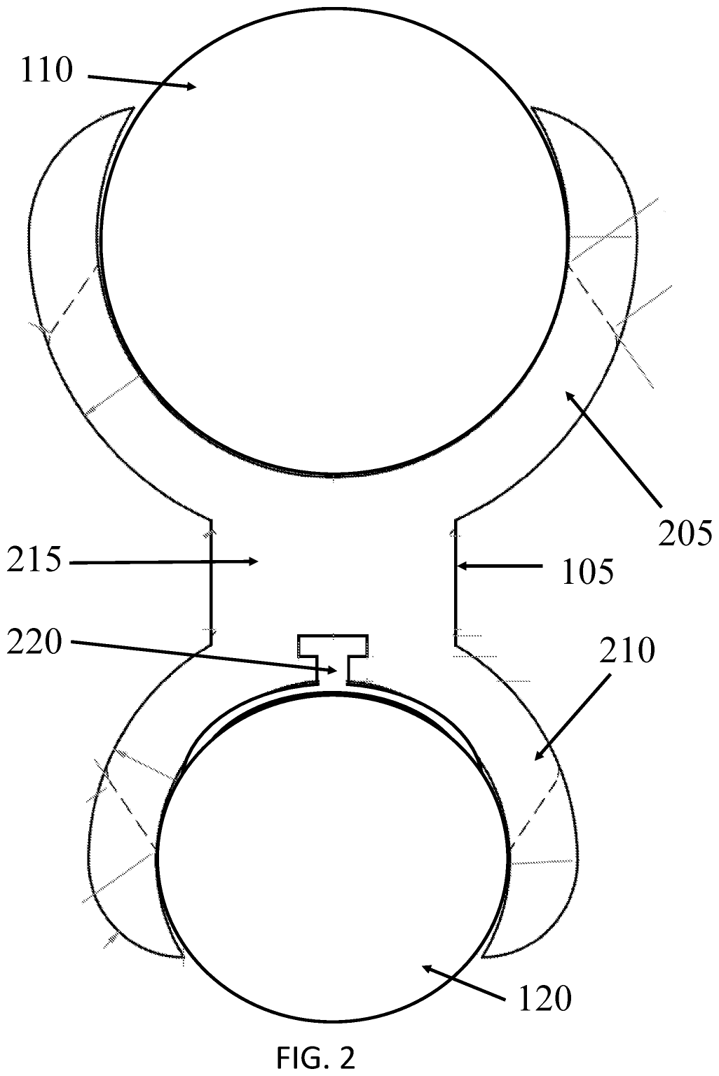

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

A mounting bracket system 100 according to one example is illustrated in FIG. 1. The mounting bracket system 100 includes a mounting bracket 105 that secures a part 110 to a frame and/or chassis 115 of vehicle. In the illustrated example, the mounting bracket 105 is secured to a strut 120 or other support member of the chassis 115 of the vehicle. In one form, the part 110 is a cannister or reservoir for high-performance shock absorbers such as those used in racing or off-road vehicles. The cannister provides additional volume to receive shock absorber fluid (e.g., oil) and/or gas (e.g., nitrogen) from the shock absorber. The canister helps to dissipate heat and reduce mixing of the fluid and gas so as to facilitate greater control of the shock absorber characteristics. During racing, these canisters are prone to damage such that the cannisters need to be quickly replaced. Moreover, the canisters may need to be swapped out for different ones depending on the desired vehicle handling characteristics. The mounting bracket system 100 allows these shock absorber canisters to be quickly and conveniently replaced by hand (i.e., manually) with little or no tools. In other variations, the mounting bracket system 100 is used to secure other types of parts 110, such as fuel filters or oil filters. In some use cases, the mounting bracket system 100 further includes a tie-down strap 125, such as in the form of a zip tie or cable tie, to further secure the mounting bracket 105 to the strut 120 of the chassis 115 and/or to secure the mounting bracket 105 to the part 110.

As illustrated in FIG. 2, the mounting bracket 105 has a part clamp 205, a chassis clamp 210, and an arm 215 extending between the part clamp 205 and the chassis clamp 210. The part clamp 205 is configured to secure the part 110 to the vehicle, and the chassis clamp 210 is configured to secure the mounting bracket 105 to the strut 120 or other member of the chassis 115. In one embodiment the arm 215 may have a relatively small length to keep a shorter distance between the part 110 and chassis 115. In other embodiments, the arm 215 may have a greater length for a more convenient placement of the part 110. The mounting bracket 105 in one version has a unitary construction in which the part clamp 205, the chassis clamp 210, and the arm 215 are integrally formed together. In one version, the mounting bracket 105 is made of plastic, and more specifically, the mounting bracket 105 is made by injection molding the plastic. The mounting bracket 105 can be made of other materials, such as metal and/or fiber reinforced materials (e.g., carbon fiber). In the chassis clamp 210, the mounting bracket 105 in some examples further has a non-slip insert or liner 220 that inhibits rotation or slippage of the mounting bracket 105 relative to the strut 120.

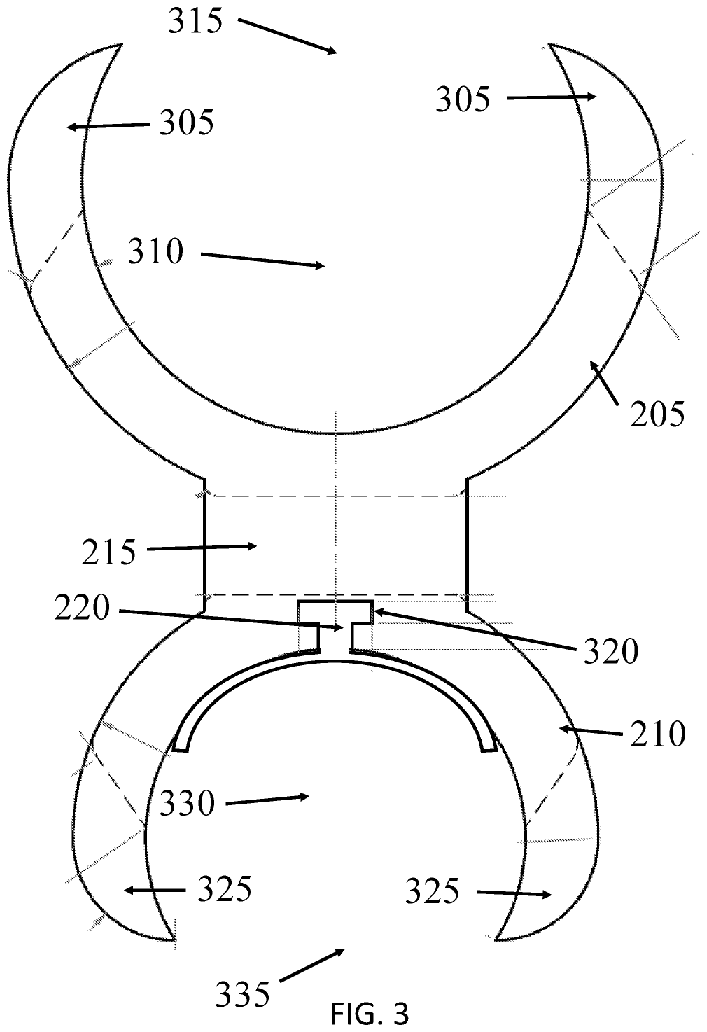

As illustrated in FIG. 3, the part clamp 205 has one or more part prongs 305 configured to grip the part 110. The part prongs 305 of the part clamp 205 define a part cavity 310 in which the part 110 is received. In one example the arm 215 is integrally formed with the part prongs 305 to define a symmetrical concave form of the part cavity 310 of which the center point is aligned with the center point of the arm 215. In other examples the part cavity 310 and arm 215 may be arranged in different directions relative to one another to accommodate various shapes and sized of the part 110. The part prongs 305 of the part clamp 205 further define a part opening 315 through which the part 110 is received during mounting and removal. The part prongs 305 are flexible and able to bend when the part 110 is inserted into and out of the part opening 315. Once the part 110 is inserted, the part prongs 305 flex back to grip the part 110. The flexible nature of the part clamp 205 allows the part 110 to be detachably coupled to the mounting bracket 105. The part prongs 305 exhibit enough flexibility, allowing the part 110 to be secured and/or removed manually. In one embodiment, the distal ends of the part prongs 305 are thinner than the proximal end to create less surface area for the part 110 to contact at the part opening 315. In one example where the part 110 has a cylindrical shape, the part prongs 305 of the part clamp 205 generally extend in a cylindrical manner so that the part cavity 310 has a cylindrical shape. The part prongs 305 can be shaped in other manners to accommodate parts 110 having different shapes (e.g., shapes that are not cylindrical).

The chassis clamp 210 defines a strut liner slot 320 configured to retain the liner 220 in the chassis clamp 210. The strut liner slot 320 in one form only extends partially the width of the mounting bracket 105 so as to retain the liner 220 during installation. In one form, the strut liner slot 320 is T-shaped so as to form a retention joint with the liner 220. Once more, the liner 220 is adapted to reduce slippage between the chassis clamp 210 and the strut 120 of the chassis 115. The chassis clamp 210 has one or more chassis prongs 325 configured to grip the strut 120 of the chassis 115. The chassis prongs 325 of the chassis clamp 210 define a chassis cavity 330 in which the strut 120 is received. In one example the arm 215 is integrally formed with the chassis prongs 325 to define a symmetrical concave form of the chassis cavity 330 of which the center point is aligned with center point of the arm 215. In other examples the chassis cavity 330 and arm 215 may be arranged in different directions relative to one another to accommodate various locations strut 120. The chassis prongs 325 of the chassis clamp 210 further define a chassis opening 335 through which the strut 120 is received during mounting and removal. The chassis prongs 325 are flexible and able to bend when the strut 120 is inserted into and out of the chassis opening 335. Once the strut 120 is inserted, the chassis prongs 325 flex back to grip the strut 120 of the chassis 115. The flexible nature of the chassis clamp 210 allows the strut 120 to be detachably coupled to the mounting bracket 105. The chassis prongs 325 exhibit enough flexibility, allowing the strut 120 to be secured and/or removed manually. In one embodiment, the distal ends of the chassis prongs 325 are thinner than the proximal ends to create less surface area for the strut 120 to contact at the chassis opening 335. In one example where the strut 120 has a cylindrical shape (e.g., a tube), the chassis prongs 325 of the chassis clamp 210 generally extend in a cylindrical manner so that the chassis cavity 330 has a cylindrical shape. The chassis prongs 325 can be shaped in other manners to accommodate struts 120 having different shapes (e.g., shapes that are not cylindrical). In another embodiment the chassis prongs 325 may be permanently affixed to the strut 120 of the chassis 115 to further secure the mounting bracket 105 keeping the same flexibility of the part clamp 205 to secure and remove the part 110 manually.

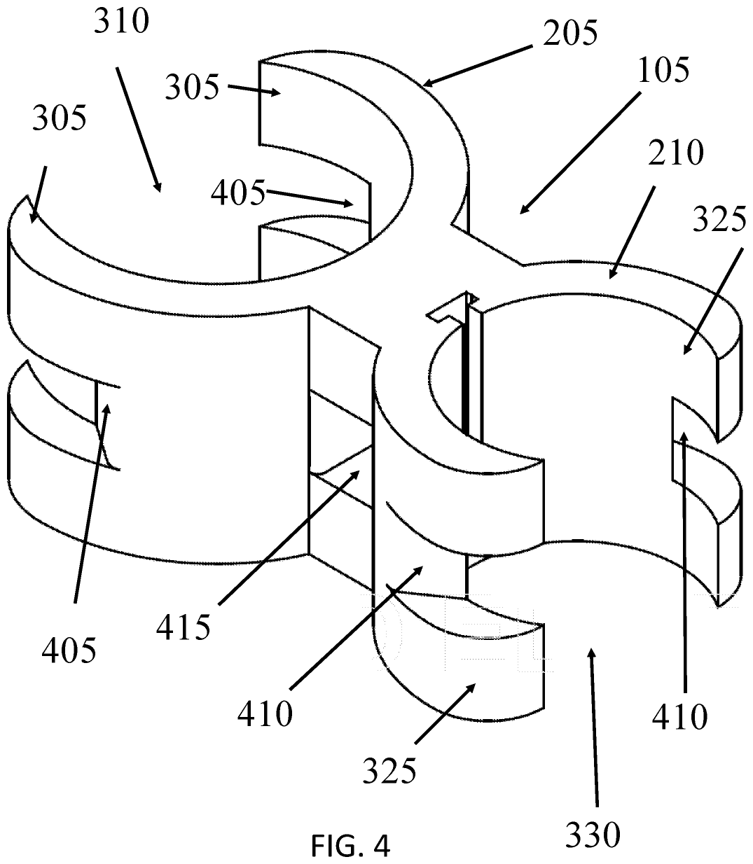

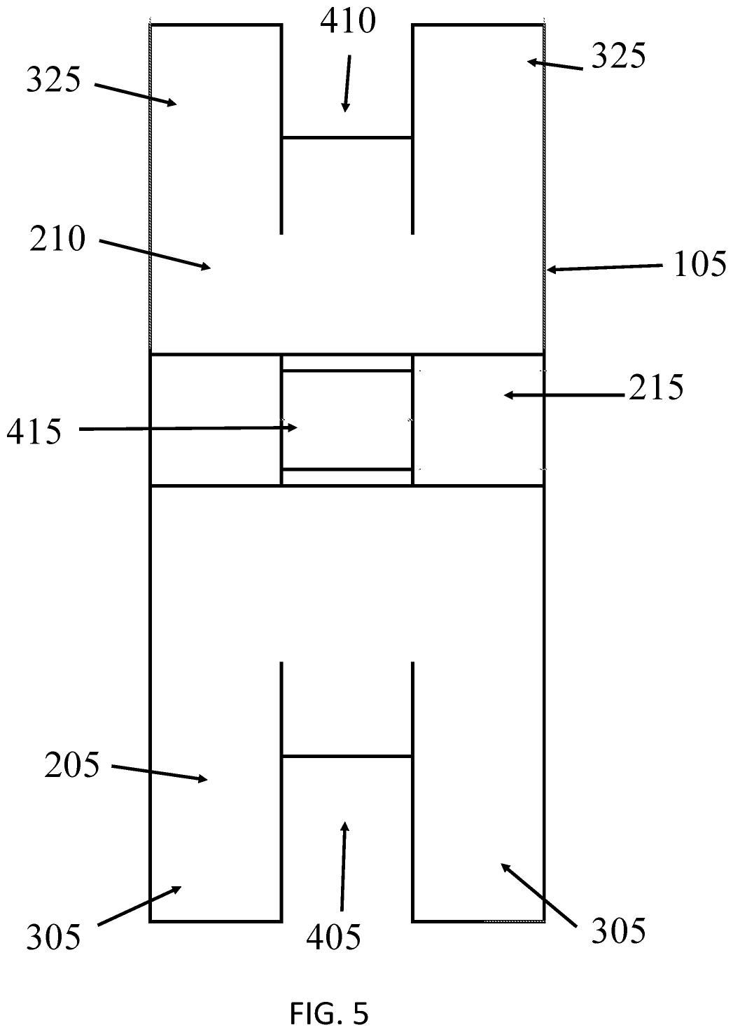

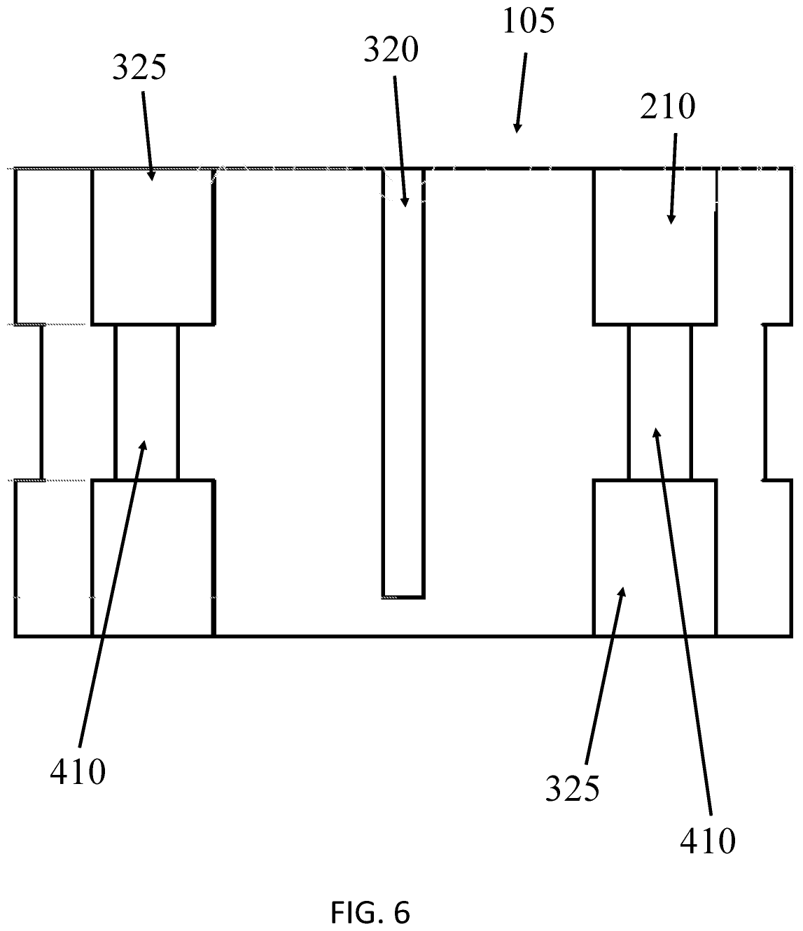

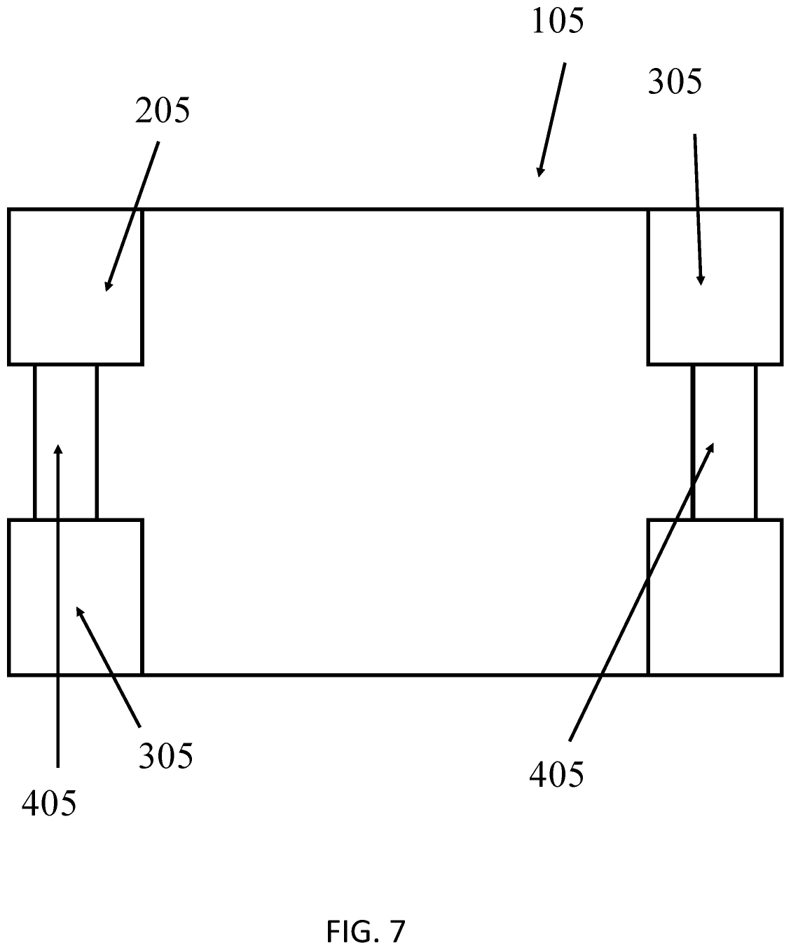

In the example illustrated in FIGS. 4, 5, 6, and 7, the part clamp 205 on opposing sides of the part cavity 310 has at least two part prongs 305 that define one or more part strap notches 405 where the strap 125 (e.g., zip tie) extends to further secure the part 110, if needed. Likewise, the chassis clamp 210 on each side of the chassis cavity 330 has at least two chassis prongs 325 that define one or more chassis strap notches 410 where the strap 125 (e.g., zip tie) extends to further secure the mounting bracket 105 to the strut 120. The part strap notches 405 are curved inward towards the part cavity 310 to keep any strap 125 at least partially below the outer surface of the part prongs 305 when secured and to prevent damage of the strap 125 upon securing. Similarly, the chassis strap notches 410 are curved inward towards the chassis cavity 330 to keep any strap 125 at least partially below the outer surface of the chassis prongs 325 when secured and to prevent damage of the strap 125 upon securing. The arm 215 defines a strap passage 415 or strap hole through which one or more straps 125 extend to further secure the part 110 and/or strut 120 to the mounting bracket 105. In one example the hole forms a rectangular shape. In other embodiments, the hole can be shaped in other manners to accommodate various straps 125.

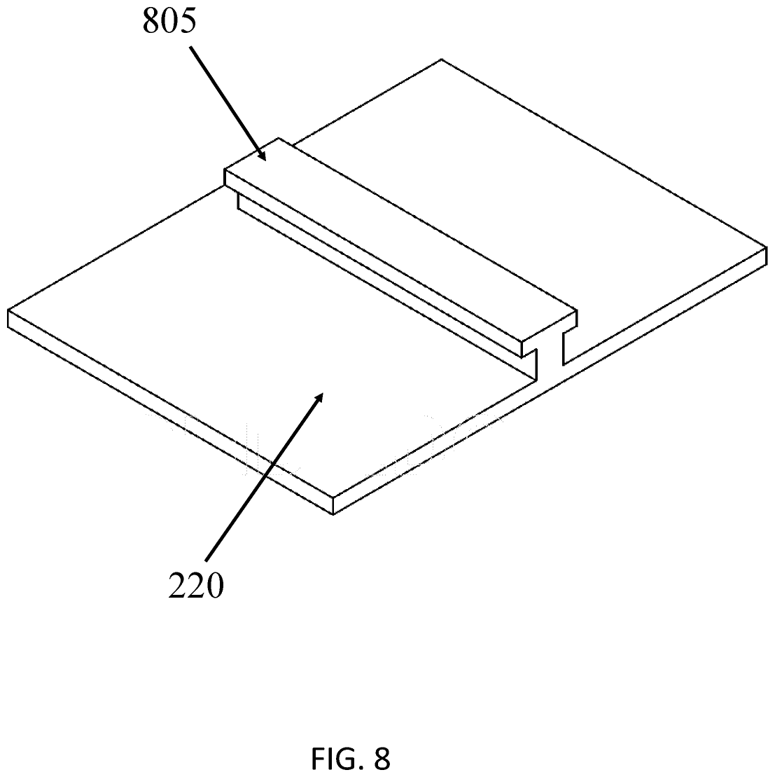

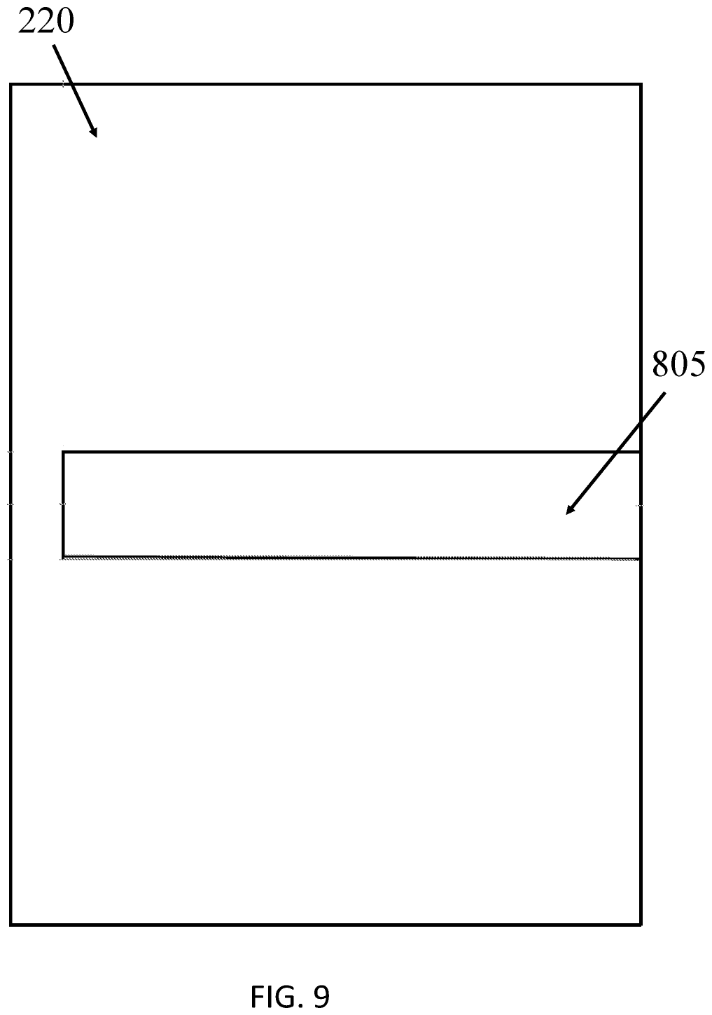

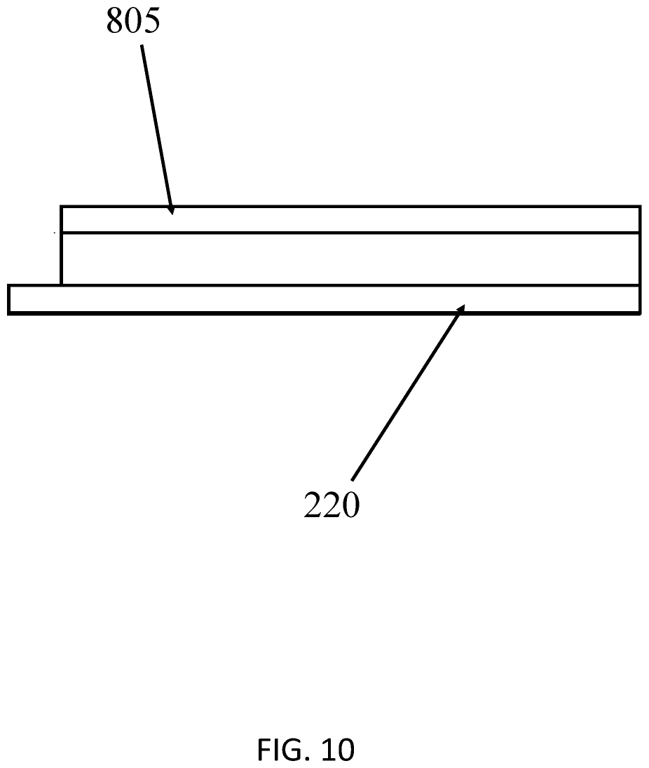

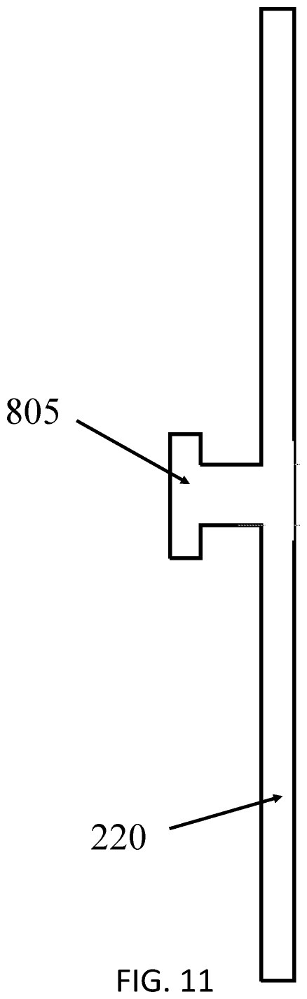

To reduce rotational, longitudinal, or other slippage between the chassis clamp 210 and the strut 120, the liner 220 is sandwiched between the chassis clamp 210 and the strut 120. FIGS. 8-11 illustrate an example of the liner 220. The liner 220 has a rail 805 that is received in the strut liner slot 320 of the mounting bracket 105 so as to retain the liner 220 in the chassis clamp. In one form, the rail 805 is T-shaped so as to form a joint with the strut liner slot 320. In one form the liner 220 does not extend past the part strap notches 405 to prevent contact of the liner 220 with any strap 125. In one form, the liner 220 is made from resilient material, like a foam material and/or rubber padding material, that increases friction between the mounting bracket 105 and the strut 120. In one particular embodiment, the non-slip liner 220 is a rubber padding liner 220 made of an elastic material, such as thermoplastic polyurethane (TPU).

During assembly, the T shaped rail 805 of the liner 220 is inserted into the T-shaped slot of the chassis clamp 210. During installation, the chassis clamp 210 with the liner 220 is clipped onto the strut 120. In some cases, the tie-down strap 125, such as the zip tie, is threaded through the strap passage 415 in the arm 215. The tie-down strap 125 is looped through the chassis strap notches 410 between the chassis prongs 325 of the chassis clamp 210, and once the mounting bracket 105 is properly positioned, the strap 125 is tightened further securing the chassis clamp 210 to the strut 120 of the chassis 115. The part 110, such as the shock absorber cannister, is then clipped to the part clamp 205 of the mounting bracket 105. In other variations, the part 110 is secured to the part clamp 205 before or at the same time as the chassis clamp 210 is secured to the chassis 115. Alternatively or additionally, one or more straps 125 can be used to further secure the part 110 to the mounting bracket 105.

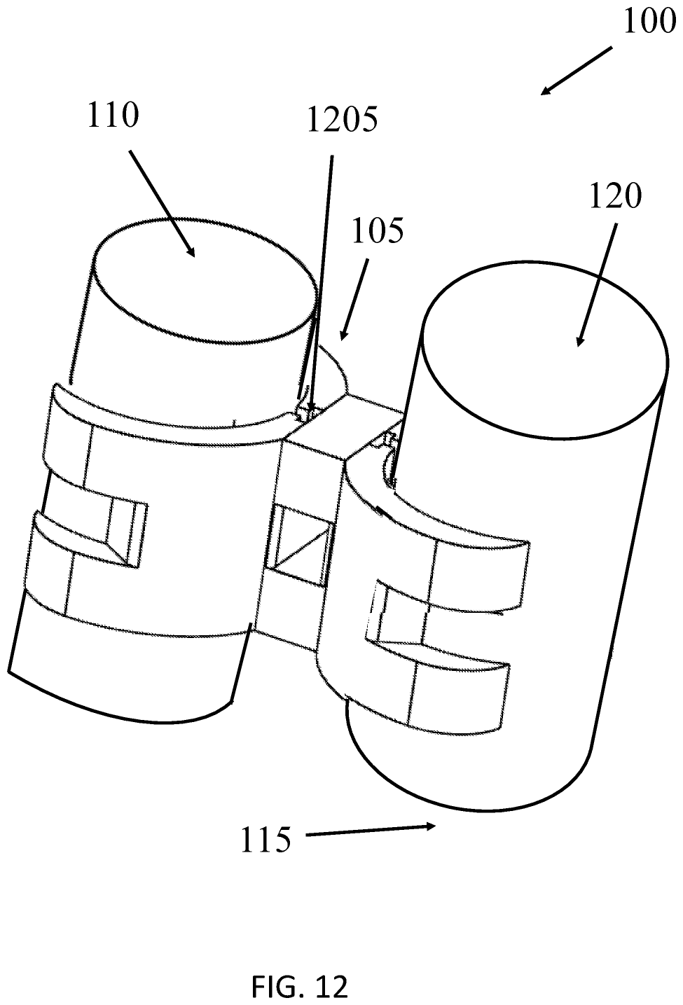

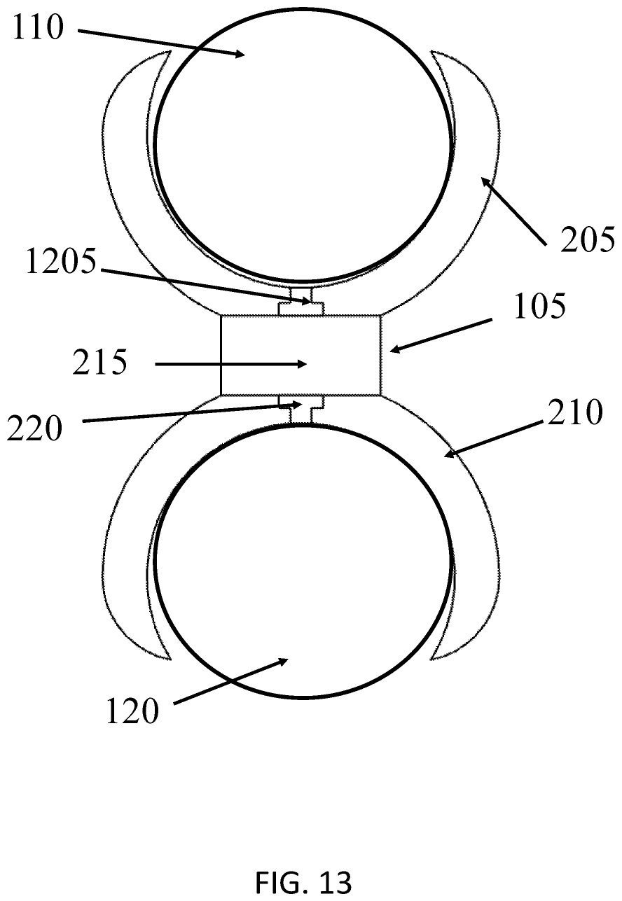

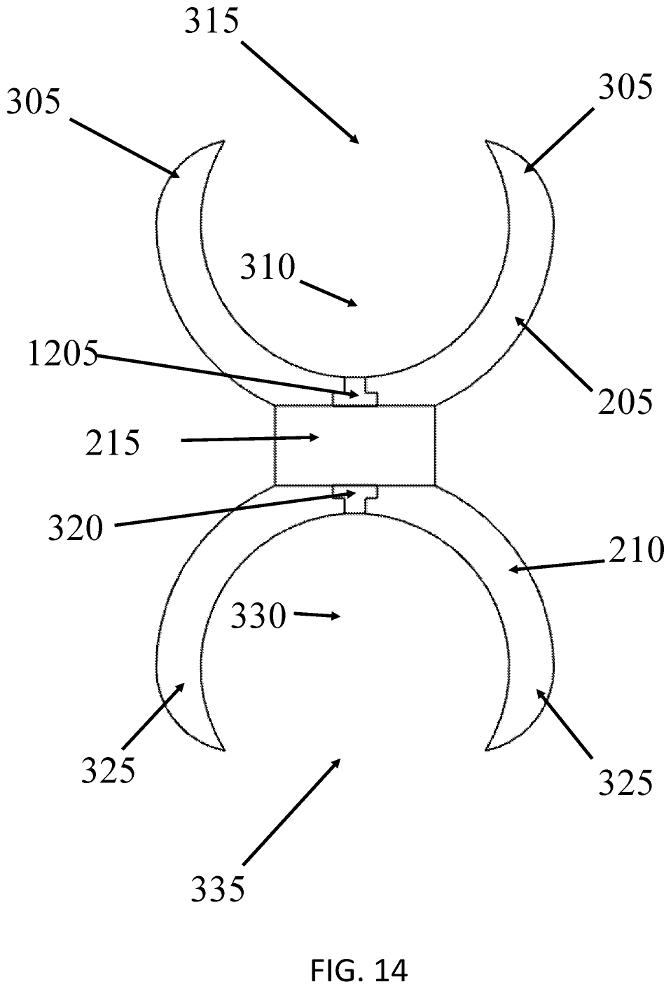

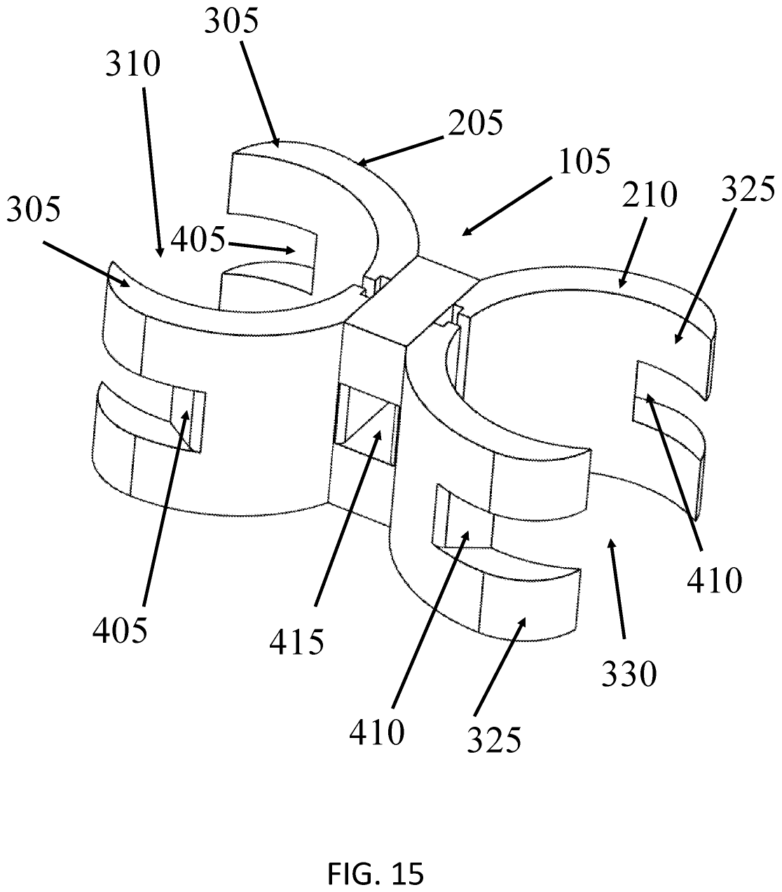

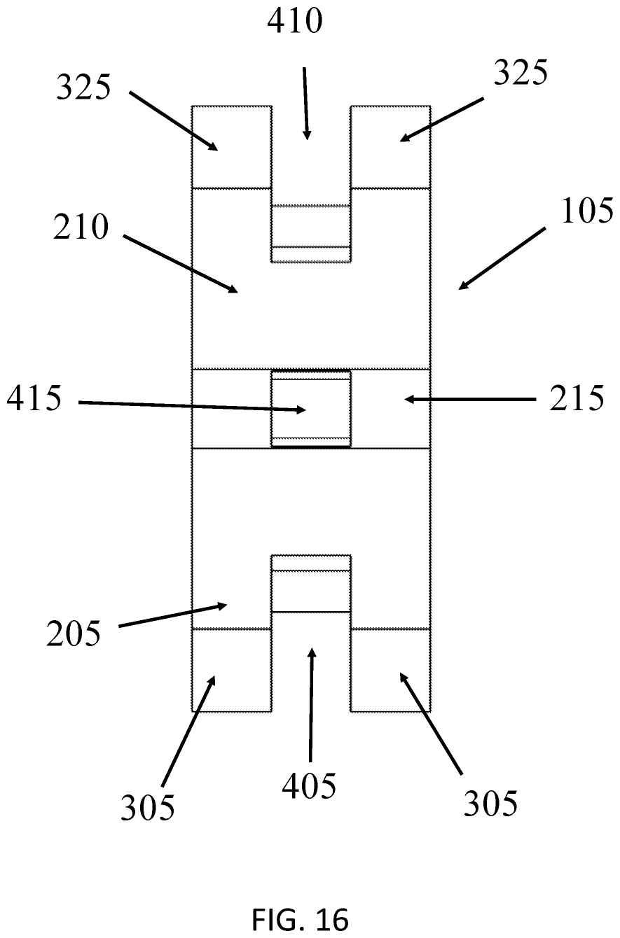

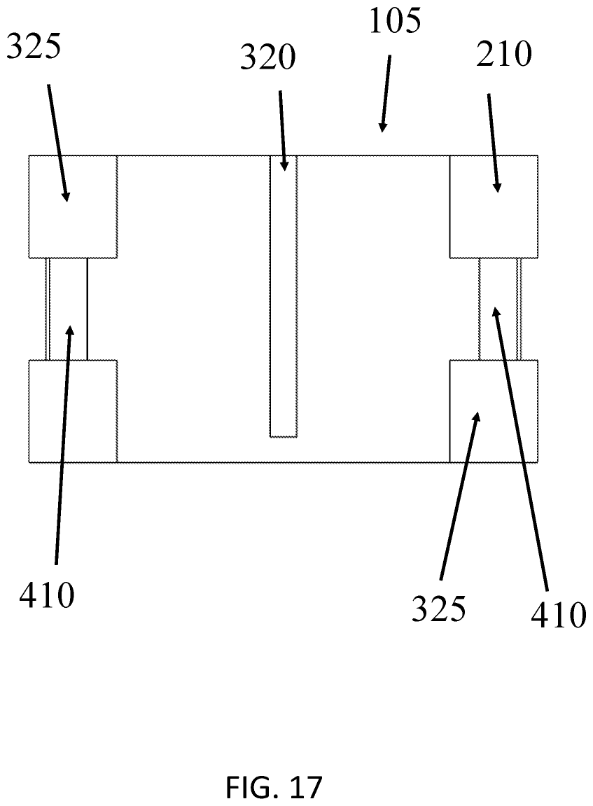

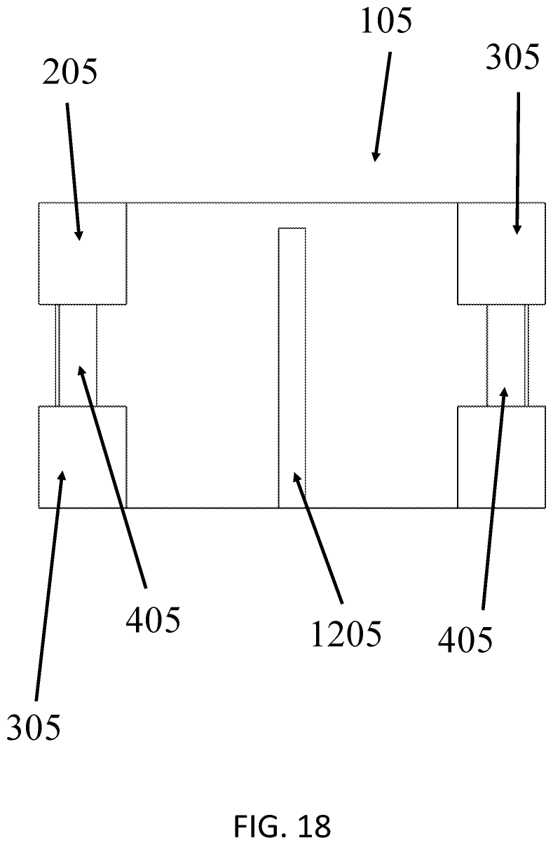

FIGS. 12, 13, 14, 15, 16, 17, and 18 illustrate another example of the mounting bracket system 100. In the illustrated example, the part clamp 205 and chassis clamp 210 are identical in size. In other embodiments the part clamp 205 and chassis clamp 210 may vary in sizes to accommodate corresponding sizes of the part 110 and strut 120. The part clamp 205 defines a part liner slot 1205 configured to retain a second liner 220 in the part clamp 205. The part liner slot 1205 in one form only extends partially the width of the mounting bracket 105 so as to retain the liner 220 during installation. In one form, the part liner slot 1205 is T-shaped so as to form a retention joint with the liner 220. The second liner 220 is adapted to reduce slippage between the part clamp 205 and the part 110.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Adhesive” generally refers to any non-metallic substance applied to one or both surfaces of two separate parts that binds them together and resists their separation. For example, an adhesive can bond both mating surfaces through specific adhesion (e.g., molecular attraction), through mechanical anchoring (e.g., by flowing into holes in porous surfaces), and/or through fusion (e.g., partial solution of both surfaces in the adhesive or its solvent vehicle). Some non-limiting examples of adhesives include liquid adhesives, film adhesives, resin adhesives, rubber adhesives, silicone-based adhesives, mastics, metal-to-metal adhesives, plastic adhesives, rubber adhesives, sprayable adhesives, and hot melt adhesives, to name just a few.

“Anchor” generally refers to a structure that serves to firmly secure and/or hold an object. In other words, an anchor is a structure to which an object is fixed to prevent substantial movement.

“Asymmetric” or “Asymmetrical” generally refers to a property of something having two sides or halves that are different from one another, such as in shape, size, and/or style. In other words, asymmetric describes something lacking a mirror-image quality.

“Axis” generally refers to a straight line about which a body, object, and/or a geometric figure rotates or may be conceived to rotate.

“Carbon Fiber Material” refers generally to a type of fiber reinforced material that includes, but is not limited to, a material of thin, strong crystalline filaments of carbon, used as a strengthening material, such as in resins and ceramics. For example, carbon fiber materials include strong lightweight synthetic fibers made especially by carbonizing a fiber at high temperatures.

“Cavity” generally refers to an empty space in a solid object. The cavity can be completely or partially surrounded by the solid object. For example, the cavity can be opened to the surrounding environment.

“Chassis” generally refers to an internal frame and/or supporting structure that supports an external object, body, and/or housing of the vehicle and/or electronic device. In one form, the chassis can further provide protection for internal parts of the vehicle and/or electronic device. By way of non-limiting examples, a chassis can include the underpart of a vehicle, including the frame on which the body is mounted. In an electronic device, the chassis for example includes a frame and/or other internal supporting structure on which one or more circuit boards and/or other electronics are mounted.

“Concave” generally refers to a surface that curves inward, or is thinner in the middle than on the edges. For example, the surface of a griddle may be concave if the surface slopes downward from the outer edge towards the middle section. Concavity in a surface generally creates a low spot in the center that liquids will flow towards.

“Continuous” generally refers to something marked by uninterrupted extension in space, time, and/or sequence. For example, a continuous line or surface has no gaps and/or holes in it. In other words, something that is continuous is unbroken.

“Couple” or “Coupled” generally refers to an indirect and/or direct connection between the identified elements, components, and/or objects. Often the manner of the coupling will be related specifically to the manner in which the two coupled elements interact.

“Direct” or “Directly Mounted” generally refers to a mounting configuration in which a first item is mounted to a second item without any intermediaries between the items. For example, a wooden block screwed onto a wall, without anything between the wall and the block, is directly mounted to the wall. Put differently, an item is directly mounted to another item if there are no other objects between the items.

“Elastic” generally refers to a solid material and/or object that is capable of recovering size and/or shape after deformation. Elastic material typically is capable of being easily stretched, expanded, and/or otherwise deformed, and once the deforming force is removed, the elastic material returns to its original shape. By way of non-limiting examples, elastic materials include elastomers and shape memory materials. For instance, elastic materials can include rubber, both natural and synthetic, and plastics.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Fiber Reinforced Material” refers generally to any material including fibers of high strength and modulus embedded in or bonded to a matrix with distinct interfaces (boundary) between them. In one example, the fiber reinforced material includes a fiber reinforcement and an encapsulating matrix. A fiber (a fiber or fiber tow typically includes a bundle of filaments) is generally considered to be continuous if the fiber extends from one edge of a ply of material to another edge, most often the opposing edge. While all fibers in a fiber reinforced material need not be continuous, a substantial majority of the fibers will be continuous in some examples.

“Frame” generally refers to a structure that forms part of an object and gives strength and/or shape to the object.

“Integrally Formed” generally refers to a component and/or multiple components that are fused into a single piece. Integrally formed components are incapable of being dismantled without destroying the integrity of the component.

“Interchangeable” generally refers to two or more things that are capable of being put and/or used in place of each other. In other words, one thing is capable of replacing and/or changing places with something else. For example, interchangeable parts typically, but not always, are manufactured to have nearly the same structural size as well as shape within normal manufacturing tolerances and have nearly the same operational characteristics so that one part can be replaced by another interchangeable part. In some cases, the interchangeable parts can be manufactured and/or sold by a specific company under the same part or Stock Keeping Unit (SKU) identifier, and in other cases, different companies can manufacture and/or sell the same interchangeable parts.

“Manual” generally refers work done by human hand and not via machine, tool, and/or electronics.

“Metallic” generally refers to a material that includes a metal, or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Mounted” generally refers to an object being physically attached to and/or held in place with respect to a support, frame, and/or chassis.

“Notch” generally refers to an indentation, cut, groove, channel, and/or incision on an edge or surface. In some non-limiting examples, the notch includes a V-shaped or U-shaped indentation carved, scratched, etched, stamped, and/or otherwise formed in the edge or surface. The notch can have a uniform shape or a non-uniform shape.

“Plastic” generally refers to a synthetic or semi-synthetic material made from a wide range of organic polymers, such as polyethylene, PVC, nylon, and the like. Typically, but not always, plastics are mostly thermoplastic or thermosetting polymers of high molecular weight and that can be made into objects, films, or filaments. In some cases, plastics can be molded into shape while soft and then set into a rigid or slightly elastic form.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 mounting bracket system
105 mounting bracket
110 part
115 chassis
120 strut
125 strap
205 part clamp
210 chassis clamp
215 arm
220 liner
305 part prongs
310 part cavity
315 part opening
320 strut liner slot
325 chassis prongs
330 chassis cavity
335 chassis opening
405 part strap notches
410 chassis strap notches
415 strap passage
805 rail
1205 part liner slot

What is claimed is:

1. A system, comprising:
a mounting bracket including
a chassis mount configured to couple to a chassis of a racing vehicle;
a part clip configured to attach to an additional racing part by manual operation; and
wherein the chassis mount is coupled to the part clip.

2. The system of claim 1, further comprising:
an arm connecting the chassis mount to the part clip.

3. The system of claim 1, further comprising:
a liner disposed in the chassis mount to prevent slippage between the chassis mount and the chassis.

4. The system of claim 3, wherein:
the chassis mount defines a liner slot; and
the liner has a rail received in the liner slot.

5. The system of claim 1, further comprising:
a strap configured to secure the mounting bracket to the chassis.

6. The system of claim 5, further comprising:
an arm connecting the chassis mount to the part clip; and
wherein the arm defines a strap passage through which the strap extends.

7. The system of claim 5, wherein the strap includes a zip tie.

8. The system of claim 5, wherein:
the chassis mount has one or more chassis prongs; and
the chassis prongs define a chassis strap notch.

9. The system of claim 5, wherein:
the part clip has one or more part prongs; and
the part prongs define a part strap notch.

10. A system, comprising:
a mounting bracket including
one or more part prongs configured to clip to a vehicle part; and
an arm coupled to the part prongs.

11. The system of claim 10, wherein the vehicle part includes a shock absorber cannister.

12. The system of claim 10, wherein the vehicle part includes a fuel filter.

13. The system of claim 10, further comprising:
one or more chassis prongs configured to clip to a chassis of a vehicle; and
wherein the chassis prongs are coupled to the arm.

14. The system of claim 13, further comprising:
a strap configured to secure the mounting bracket to the chassis.

15. The system of claim 14, wherein the arm defines a strap passage through which the strap extends.

16. The system of claim 15, wherein the chassis prongs define a chassis strap notch.

17. The system of claim 13, further comprising:
a liner disposed in the chassis prongs to prevent slippage between the chassis prongs and the chassis.

18. The system of claim 17, wherein:
the chassis prongs define a liner slot; and
the liner has a rail received in the liner slot.

19. A method, comprising:
decoupling a part clip of a mounting bracket from a racing part through manual operation; and
coupling a replacement racing part to the part clip through manual operation.

20. The method of claim 19, further comprising:
coupling the mounting bracket to a vehicle.
